(19) United States
(12) Patent Application Publication
(10) Pub. No.: US 2026/0295497 A1
(43) Pub. Date: Oct. 1, 2026

(54) A METHOD OF CAPTURING CARBON DIOXIDE FROM ATMOSPHERIC AIR

(71) Applicant: REPSOL, S.A., MADRID (ES)

(72) Inventors: Micaela TABORGA CLAURE, MÓSTOLES (ES); Fernando REY GARCIA, VALENCIA (ES); Susana VALENCIA VALENCIA, VALENCIA (ES); Miguel PALOMINO ROCA, VALENCIA (ES); María Teresa NAVARRO VILLALBA, VALENCIA (ES)

(21) Appl. No.: 19/489,818

(22) PCT Filed: Jun. 11, 2024
(86) PCT No.: PCT/EP2024/066024

§ 371 Date: Dec. 3, 2025

(30) Foreign Application Priority Data
Jun. 12, 2023 (EP) 23382582.7

(51) Int. Cl. B01D 53/04

(52) U.S. Cl. CPC B01D 53/04; B01D 2221/16; B01D 2253/1085; B01D 2257/504; B01D 2259/40088

(57) ABSTRACT

It is provided a method of capturing carbon dioxide from atmospheric air, the method comprising contacting the atmospheric air with a calcium chabazite having a Si/Al atomic ratio from 1.0 to 2.3 and a Ca/Al atomic ratio from 0.30 to 0.50, such that the carbon dioxide in the atmospheric air is adsorbed by the calcium chabazite and a CO₂-containing calcium chabazite is obtained, wherein the atmospheric air has a CO₂ content in a range from 200 ppm to 1000 ppm, wherein atmospheric air has a pressure of 1013±150 mbar; and wherein the method is carried out at a temperature from −10° C. to 50° C. It is also provided the use of a device comprising the mentioned calcium chabazite for capturing CO₂ from a atmospheric air having a CO₂ content from 200 ppm to 1000 ppm.

This application claims the benefit of European Patent Application EP23382582.7 filed on Jun. 12, 2023.

### TECHNICAL FIELD

The present disclosure relates to the field of calcium-containing zeolites that are useful for the capture of carbon dioxide (CO₂) from a low-CO₂-content gaseous source which is atmospheric air. More particularly, it relates to calcium-containing chabazites and their use for removing carbon dioxide from atmospheric air.

### BACKGROUND ART

Burning of fossil fuels has increased the amount of carbon dioxide in the atmosphere contributing to the greenhouse effect. Reduction in CO₂ emissions by limiting fossil energy resources seems to be extremely difficult given the increasing energy demand. Therefore, an option of minimizing the level of carbon dioxide in the atmosphere can be performed by selectively adsorbing away carbon dioxide from the atmosphere.

Direct air capture (DAC) may be used for diminishing the global amount of CO₂ in the atmosphere, where it is at low concentrations of ca. 400 ppm CO₂. DAC technologies extract CO₂ directly from the atmosphere at any location, unlike carbon capture which is generally carried out at the point of emissions, such as a flue gas. Besides, it may be useful for other applications such as for air purification in enclosed spaces like in office buildings, hospitals, aircrafts, and so on. Additionally, the adsorbed CO₂ can later on be recovered as a source for several industrial processes such as the production of synthetic fuels or carbonates (e.g. via mineralization in-situ including geological reservoirs or ex-situ for the production of aggregates).

The CO₂ in the atmosphere is much more dilute than in, for example, flue gas from power plants or cement plants. This makes that capturing CO₂ from the air requires specific technologies. In order to create efficient capture technologies for low concentration CO₂ environments, there is a need for new adsorbents.

Capture of CO₂ requires an effective and economic adsorbent with good selectivity versus other components in the air. Zeolites are physisorbents that have been investigated for this purpose. However, when used for DAC, that is involving low concentrations of CO₂, they result in low CO₂ adsorption capacities.

Willson et al. (cf. Wilson, S. M., & Tezel, F. H. (2020). Direct dry air capture of CO₂ using VTSA with faujasite zeolites. Industrial & Engineering Chemistry Research, 59(18), 8783-8794, citing Stuckert, N. & Yang, R. (2011). CO₂ Capture from the Atmosphere and Simultaneous Concentration Using Zeolites and Amine-Grafted SBA-15. Environmental science & technology. 45(23), pp. 10257-64) reported several zeolites for DAC with relatively good adsorption capacities. Among them, faujasites Li-LSX, Na-LSX, and Ca-LSX provided the best adsorption capacities with values of 1.34, 0.87, and 0.76 mmol/g at 395 ppm of CO₂ at 25° C. It is worth noticing that Ca-exchanged faujasite, having a Ca/Al ratio of 0.42 (i.e. 84% Ca exchange) provided the worst CO₂ adsorption. CO₂ uptake values at concentrations lower than 500 ppm and temperatures between 2° and 30° C. of up to 1.5 mmol/g have been reported in the literature for zeolites (cf. Low, M. Y. A., Barton, L., Pini, R., & Petit, C. (2023). Analytical review of the current state of knowledge of adsorption materials and processes for direct air capture. Chemical Engineering Research and Design, 189, 745-767).

Calcium-exchanged chabazites have been reported for CO₂ capture from flue gas (cf. Zhang, J. et al. (2008), “Alkali and alkaline earth cation exchanged chabazite zeolites for adsorption based CO₂ capture,” Microporous Mesoporous Materials, p. 478-487; Du, T. et al. (2017). Preparation of zinc chabazite (ZnCHA) for CO₂ capture. Research on Chemical Intermediates. 43, 1783-1792). However, the results from the direct CO₂ capture from flue gas, which comprises relatively large amounts of CO₂ (that is, partial pressures of CO₂ of around 150 mbar) cannot be extrapolated to CO₂ capture under DAC conditions, since partial pressure of CO₂ in air is extremely lower, that is, of around 0.4 mbar (ca. 400 ppm).

An adsorbent that is effective for capturing CO₂ from gasses having a high CO₂-content do not necessarily exhibit a similar performance in the gasses having relatively low CO₂ concentrations. In fact, in general, for all zeolites, the adsorption of CO₂ drops sharply when used for DAC. As an instance, as shown in FIG. 3 and FIG. 7 below, for instance, Na-LTA-5 and Na-FAU-2 (their structural and chemical compositions are described below) did show practically no CO₂ uptake for 400 ppm CO₂.

Therefore, there remains a need for a selective and efficient adsorbents having greater CO₂ adsorption capacities at relatively low CO₂ concentrations such as for DAC.

### SUMMARY OF INVENTION

The inventors have found that a Ca-chabazite of Si/Al ratio from 1.0 to 2.3 and a Ca/Al atomic ratio from 0.30 to 0.50 provided an outstanding CO₂ adsorption at ultra-low partial pressure of CO₂ (of around 0.4 mbar, i.e., similar to that of the atmosphere or even lower). Surprisingly, at a partial CO₂ pressure of about 0.4 mbar (ca. 400 ppm) a CO₂ adsorption of 2.05 mmol/g or higher was achieved (see FIG. 15).

Thus, the calcium chabazite disclosed herein can be used for capturing CO₂ from atmospheric air, having a low-CO₂-content, where the CO₂ content is in a range from 200 ppm to 1000 ppm (concentrations referred to volumes measured at standard temperature and pressure).

Thus, a first aspect of the present disclosure relates to a method of capturing carbon dioxide from an atmospheric air, the method comprising contacting the atmospheric air with a calcium chabazite having a Si/Al atomic ratio from 1.0 to 2.3 and a Ca/Al atomic ratio from 0.30 to 0.50, such that the carbon dioxide in the atmospheric air is adsorbed by the calcium chabazite, wherein the atmospheric air has a CO₂ content in a range from 200 ppm to 1000 ppm measured at standard temperature and pressure; wherein atmospheric air has a pressure of 1013±150 mbar; and wherein the method is carried out at a temperature from −10° C. to 50° C.

Another aspect of the present disclosure relates to the use of a device comprising a calcium chabazite as defined herein above and below for capturing CO₂ from atmospheric air having a CO₂ content from 200 ppm to 1000 ppm, or from 350 to 900 ppm, or from 350 to 800 ppm, or from 350 to 700 ppm, or from 350 to 600 ppm, or from 350 to 500 ppm, or from 350 to 450 ppm, or from 350 to 425 ppm.

### BRIEF DESCRIPTION OF DRAWINGS

FIG. 1 shows the XRD patterns of as made Na,H-LTA zeolites with different Si/Al ratios shown in Table 1.

FIG. 2 shows the XRD patterns of Ca-LTA zeolites shown in Table 1.

FIG. 3a shows the CO₂ isotherms on Na,H-LTA zeolites at 25° C. shown in Table 1. (FIG. 3b, ultra-low pressure range isotherm).

FIG. 4a shows the CO₂ isotherms on Ca-LTA zeolites at 25° C. shown in Table 1. (FIG. 4b, ultra-low pressure range isotherm).

FIG. 5 shows the XRD patterns of Na-FAU zeolites shown in Table 2.

FIG. 6 shows the XRD patterns of Ca-FAU zeolites shown in Table 2.

FIG. 7a shows the CO₂ isotherms on zeolites Na-FAU-1 and Na-FAU-2 at 25° C. shown in Table 2. (FIG. 7b, ultra-low pressure range isotherm).

FIG. 8a shows the CO₂ isotherms on zeolites Ca-FAU at 25° C. shown in Table 2. (FIG. 8b, ultra-low pressure range isotherm).

FIG. 9 shows the XRD patterns of as made CHA zeolite series shown in Table 3.

FIG. 10 shows the XRD patterns of Ca-CHA zeolite series in Table 3.

FIG. 11a shows the CO₂ isotherms on zeolites K-CHA-2, Na-CHA-2 and Na-CHA-5 shown in Table 3. (FIG. 11b, ultra-low pressure range isotherm).

FIG. 12a shows the CO₂ isotherms on zeolites Ca-CHA at 25° C. shown in Table 3. (FIG. 12b, ultra-low pressure range isotherm).

FIG. 13a shows the CO₂ isotherms on different preparations of zeolites Ca-CHA-2 at 25° C. in Table 4 for studying its reproducibility. (FIG. 13b, ultra-low pressure range isotherm).

FIG. 14a shows the CO₂ isotherms of different preparations of zeolites Ca-CHA-2 at 25° C. in Table 5 for studying the effect of the Ca/Al. FIG. 14b shows a ultra-low pressure range isotherm.

FIG. 15 shows the adsorption capacity of CO₂ of a series of zeolites Ca-CHA-2 having different Ca/Al ratios at ultra-low pressure (0.4 mbar) and 25° C. of adsorption temperature.

FIG. 16a shows the CO₂ isotherms of Ca-CHA-2 having a Ca/Al ratio of 0.46 at different temperatures of adsorption for studying the influence of the temperature of adsorption. (FIG. 16b, ultra-low pressure range isotherm).

FIG. 17 shows the CO₂ adsorption isotherms at different temperatures on Ca-CHA-2 to estimate the working capacity of the adsorbent at different adsorption-desorption cycling conditions.

### DETAILED DESCRIPTION OF THE INVENTION

All terms as used herein in this application, unless otherwise stated, shall be understood in their ordinary meaning as known in the art. Other more specific definitions terms as used in the present application are as set forth below and are intended to apply uniformly throughout the specification and claims unless an otherwise expressly set out definition provides a broader definition.

It is noted that, as used in this specification and the appended claims, the singular forms “a”, “an”, and “the” are to be construed to cover both the singular and the plural, unless otherwise indicated herein or clearly contradicted by context.

As used herein, the term “gaseous source” refers to a CO₂-containing gas mixture from which the CO₂ is being adsorbed, typically air. The gaseous source is typically present at ambient atmospheric pressure.

As used herein, the term “atmospheric pressure” refers to a pressure at 1013±150 mbar.

As used herein, the term standard temperature and pressure are 0 degrees Celsius and 1 atmosphere (atm) of pressure.

As used herein, the term “room temperature” refers to a temperature of about 20° C. to about 25° C.

As used herein, the term “relative humidity” refers to the amount of water vapour present in air expressed as a percentage of the amount needed for saturation at the same temperature.

Unless specially indicated, all materials and agents used in the present disclosure are commercially available.

Zeolites are microporous, crystalline aluminosilicate materials commonly used as commercial adsorbents, catalysts, cation exchange, and gas separation. The structure of the zeolites may be defined as a three-dimensional framework defining a pattern of cavities interconnected by channels or pores whose dimensions vary from one zeolite to another but are uniform in a given zeolite. Zeolites can be differentiated and characterized by their chemical composition and by their X-ray diffraction (XRD) pattern. They mainly consist of silicon, aluminium, oxygen, and have the general formula (Li,Na,K)ₐ(Mg,Ca,Sr,Ba)_{d}(Al_{(a+2d)}Si_{n-(a+2d)}O₂ₙ)·mH₂O. The positive ions can be exchanged for others in a contacting electrolyte solution. These exchanged zeolites are particularly useful as solid adsorbents.

Zeolite A (cf. Julbe, A., & Drobek, M. (2014). Zeolite A Type. Encyclopedia of Membranes, 1-2. doi:10.1007/978-3-642-40872-4_604-1), also known as LTA (Linde Type A) is characterized by the formula |(Na⁺₁₂(H₂O)₂₇|₈[Al₁₂Si₁₂O₄₈]₈ which corresponds to its most common hydrated sodium form (International Zeolite Association—IZA). Sodium ions in zeolite A can be exchanged with other cations such as lithium (Li-LTA), potassium (K-LTA), or calcium (Ca-LTA).

Zeolite X (c.f. Julbe, A., & Drobek, M. (2014). Zeolite X Type. Encyclopedia of Membranes, 1-2. doi:10.1007/978-3-642-40872-4_607-1), together with zeolite Y (c.f. Julbe, A., & Drobek, M. (2014). Zeolite Y: Type. Encyclopedia of Membranes, 1-2. doi:10.1007/978-3-642-40872-4_608-1), belongs to the family of aluminosilicate molecular sieves with a faujasite-type structure (FAU), which is characterized by the basic formula |(Ca, Mg, Na₂)_{x/2} (H₂O)ₘ|[AlₓSi₍₁₉₂₋ₓ₎O₃₈₄]-FAU (International zeolite association (IZA)), where Ca, Mg and Na are the counterbalance cations, but many others can be included in zeolites FAU, such as H, K, La, among others. Zeolite X differs from zeolite Y by its Si/Al atomic ratio which is typically in the range from 1 to 1.5 for the X and higher for the Y-type zeolite. The higher content of silica confers zeolite Y with higher thermal stability.

Faujasite is a rare natural zeolite, although its synthetic counterparts Linde X and Linde Y are largely used as sorbents and catalysts.

Chabazite (CHA, where the three characters indicate the framework type) is known to possess a three-dimensional pore system with large ellipsoidal cages (6.7×10 Å). Chabazite has a framework structure consisting of a stacked sequence of 6-rings in the order AABBCC . . . , forming double 6-rings at each apex of the rhombic unit cell (IZA website 2023 http://www.iza-online.org/natural/Datasheets/Chabazite/chabazite.htm). Thus, a type of cage (the chabazite cage) is typical of this structure. The largest channels perpendicular to [001](crystallographic c axis in the hexagonal setting) are confined by eight-membered rings (aperture 3.8×3.8 Å). The chabazite structure is characterised by its coordination sequence T1: 4, 9, 17, 29, 45, 64, 85, 110, 140, 173, 0, 0 as defined by Grosse-Kunstleve et al. (cf. R. W. Grosse-Kunstleve, G. O. Brunner and N. J. A. Sloane. (1996) Algebraic Description of Coordination Sequences and Exact Topological Densities for Zeolites. Acta Crystallogr. A52, 879-889) and its vertex symbols T1: 4-4-4-8-6-8 (cf. M. O'Keeffe and S. T. Hyde. (1997). Vertex symbols for zeolite nets. Zeolites 19, 370-374). where T1 makes reference to the atom in tetrahedral coordination, typically Si and/or Al. In particular, calcium chabazite has the general formula Chabazite-Ca|(Ca_{0.5},K,Na)ₓ(H₂O)₁₂|[AlₓSi₁₂₋ₓO₂₄] x=2.4-5.0.

As mentioned above, an aspect of the invention relates to a method of capturing carbon dioxide from atmospheric air, the method comprising contacting the atmospheric air with a calcium chabazite having a Si/Al atomic ratio from 1.0 to 2.3, particularly from 1.0 to 2.2, and a Ca/Al atomic ratio from 0.30 to 0.50 under the conditions mentioned above, such that the carbon dioxide in the gaseous source is adsorbed by the calcium chabazite.

As used herein, the term “contacting with a calcium chabazite” includes that the atmospheric air is passed through, over, or around the calcium chabazite to allow that at least CO₂ is adsorbed on the calcium chabazite. In an example, the calcium chabazite of the present disclosure can be configured in a way such as in a fixed bed or other suitable arrangement to allow the atmospheric air to pass through, over and/or around the calcium chabazite.

In an embodiment, optionally in combination with one or more features of the various embodiments described above, the calcium chabazite has a total CO₂ adsorption capacity from 1.75 mmol/g to 2.06 mmol/g at 0.4 mbar and 25° C.

In an embodiment, optionally in combination with one or more features of the various embodiments described above, the calcium chabazite is capable of capturing a total CO₂ from 1.75 mmol/g to 2.06 mmol/g at 0.4 mbar and 25° C.

In another embodiment, the calcium chabazite has a Si/Al atomic ratio from 1.4 to 2.2. In another embodiment, the calcium chabazite has a Si/Al atomic ratio from 1.5 to 2.2. In another embodiment, the calcium chabazite has a Si/Al atomic ratio from 1.8 to 2.2. In another embodiment, the calcium chabazite has a Si/Al atomic ratio from 1.8 to 2.2. In another embodiment, the calcium chabazite has a Si/Al atomic ratio from 1.9 to 2.2 or from 1.9 to 2.1.

In another embodiment, optionally in combination with one or more features of the various embodiments described above, the calcium chabazite has a Ca/Al atomic ratio from 0.40 to 0.50. In another embodiment, the calcium chabazite has a Ca/Al atomic ratio from 0.42 to 0.50. In another embodiment, the calcium chabazite has a Ca/Al atomic ratio from 0.45 to 0.50. In another embodiment, the calcium chabazite has a Ca/Al atomic ratio from 0.45 to 0.49. In another embodiment, the calcium chabazite has a Ca/Al atomic ratio from 0.46 to 0.48.

In another embodiment, optionally in combination with one or more features of the various embodiments described above, the calcium chabazite is in a contacted form such as monoliths, fibers, filters, mesh, coatings, pellets, or powder, or any other form easing the contact of the atmospheric air with the calcium chabazite.

As used herein, the term “contacted form” refers to a structure to (or in) which an adsorbent (such as Ca-CHA) is contacted to create a 3D structure with high surface areas where air can be contacted to (the higher the surface area, the higher the CO₂ capture from the air). Thus, in the method of the present invention the Ca-CHA can be contacted in the form of a coating on a monolith, or inside a fiber structure, or it can be directly formed into a structure such as monolithic gel structure.”

Typically, the air passes through the calcium chabazite (used as a contactor or gas-adsorbing material) where the CO₂ is captured. Afterwards, the contactor can be heated under vacuum to remove and recover the CO₂.

In atmospheric air the CO₂ content can be in a range from 200 ppm to 1000 ppm, in particular in an amount approximating the usual content of CO₂ in the atmosphere (i.e., ca. 400 ppm nowadays), but also the higher levels found in enclosed spaces such as buildings and aircrafts or in the future in the atmosphere. In another embodiment, the CO₂ content in the atmospheric air is from 300 to 900 ppm. In another embodiment, the CO₂ content in the atmospheric air is from 350 to 900 ppm. In another embodiment, the CO₂ content in the atmospheric air is from 350 to 800 ppm. In another embodiment, the CO₂ content in the atmospheric air is from 350 to 700 ppm. In another embodiment, the CO₂ content in the atmospheric air is from 350 to 600 ppm. In another embodiment, the CO₂ content in the atmospheric air is from 350 to 500 ppm. In another embodiment, the CO₂ content in the atmospheric air is from 350 to 450 ppm. In another embodiment, the CO₂ content in the atmospheric air is from 350 to 425 ppm. The CO₂ content in the atmospheric air may be defined by the combination of any one of the lower endpoints and any one of the higher endpoints defining the abovementioned ranges. Concentrations are referred to volumes measured at standard temperature and pressure.

In another embodiment, optionally in combination with one or more features of the various embodiments described above, the method is for direct air capture.

The method of the invention is usually carried out at atmospheric pressure and at atmospheric temperature. Atmospheric pressure can vary depending on several factors such as altitude, latitude, temperature, and so on.

As mentioned above, the calcium chabazite is contacted with atmospheric air at atmospheric pressure, i.e., at a pressure of 1013±150 mbar. In another embodiment, the atmospheric air has a total pressure from 913 mbar to 1133 mbar. In another embodiment, the atmospheric air has a total pressure from 1000 mbar to 1050 mbar.

In an embodiment, optionally in combination with one or more features of the various embodiments described above, the method of the invention is carried out at a temperature from 0° C. to 45° C. In another embodiment, the method of the invention is carried out at a temperature from 10° C. to 35° C. In another embodiment, the method of the invention is carried out at room temperature.

The method of the present disclosure is particularly effective under dry climate conditions.

Therefore, in an embodiment, optionally in combination with one or more features of the various embodiments described above, the method of the invention is carried out under dry conditions.

In another embodiment, optionally in combination with one or more features of the various embodiments described above, the method of the invention is carried out under dry conditions. In a particular embodiment, optionally in combination with one or more features of the various embodiments described above, the atmospheric air comprises water in an amount of up to 10 ppm (partial pressure of water of 0.01 mbar), such as from 0 ppm to 10 ppm, particularly, from 0 ppm to 5 ppm, more particularly, from 0 ppm to 2 ppm, when operating at 25° C.

In another particular embodiment, the atmospheric air comprises water in an amount of up to 5 ppm, such as from 0 ppm to 3 ppm, particularly, from 0 ppm to 1 ppm, when operating at 10° C.

In another embodiment, the method can be carried out in the presence of a desiccant (such as the commercially available desiccants Zeolite 3A, Zeolite 4A, and Zeolite P), what enables continuous operation of a designed DAC system at lower temperatures than with the calcium chabazite alone. Advantageously, by carrying out the process in the presence of a desiccant eases both the adsorption and desorption processes (see below).

The step of contacting the atmospheric air with the calcium chabazite as defined above can be carried out until reaching thermodynamic equilibrium at a given partial pressure of CO₂ and at a given temperature, that is, until no significant further adsorption is produced in such conditions.

### Calcium Chabazite Regeneration

The working capacity of the adsorbent is defined as the difference in adsorption capacity of the material between adsorption and regeneration conditions.

The adsorption capacity of the CO₂-containing calcium chabazite can be re-established at any stage, that is, regardless of whether the CO₂-containing calcium chabazite is saturated or not, by subjecting it to a desorption step.

The terms “saturated or saturation”, referred at a specific temperature, means the point at which the CO₂-containing calcium chabazite cannot adsorb more CO₂ at the mentioned temperature.

The desorption step can be carried out by heat-treating the CO₂-containing calcium chabazite at a higher temperature than the one at which the method of capturing carbon dioxide was carried out, such as to a temperature from 40° C. to 500° C., or from 50° C. to 500° C., or from 80° C. to 150° C., or from 40° C. to 80° C., or from 40° C. to 80° C.

Alternatively, or in addition to the heat treatment mentioned above, the desorption step can be carried out by subjecting the CO₂-containing calcium chabazite to a reduced pressure such as at a pressure of 50-400 mbar or of 100-300 mbar, to desorb the carbon dioxide. This further allows recovering the adsorbed CO₂, that can be subsequently used in several industrial processes such as for the production of synthetic fuels (e.g. of methanol, diesel, jet fuels, sustainable aviation fuel, and so on) or carbonates (e.g. via mineralization in-situ including in geological reservoirs, or ex-situ for the production of negative footprint aggregates).

Thus, in another embodiment, optionally in combination with one or more features of the various embodiments described above, the method of the present disclosure comprises:
(a) contacting the atmospheric air with a calcium chabazite having a Si/Al atomic ratio from 1.0 to 2.3 and a Ca/Al atomic ratio from 0.30 to 0.50, such that the carbon dioxide in the atmospheric air is adsorbed by the calcium chabazite, in particular, until no significant further adsorption is produced, in order to obtain a CO₂-containing calcium chabazite;
   wherein the atmospheric air has a CO₂ content in a range from 200 ppm to 1000 ppm measured at standard temperature and pressure;
   wherein atmospheric air has a pressure of 1013±150 mbar; and wherein the method is carried out at a temperature from −10° C. to 50° C.;
(b) subjecting the CO₂-containing calcium chabazite to a desorption step; and
(c) optionally, recovering the desorbed CO₂.

In an embodiment, the desorption step (b) is carried out by increasing the temperature (i.e., by Temperature Swing Adsorption (TSA)), by decreasing the pressure (i.e., by Vacuum Pressure Swing Adsorption (VPSA)), or by a combination thereof (i.e., by Vacuum Temperature Swing Adsorption (VTSA).

In a particular embodiment, optionally in combination with one or more features of the various embodiments described above, the desorption step (b) is carried out by heat-treating the CO₂-containing calcium chabazite at a temperature of 50° C. to 500° C. In another embodiment, the heat treating step is carried out at a temperature from 50° C. to 300° C. In another embodiment, the heat treating step is carried out at a temperature from 80° C. to 150° C. In another embodiment, the heat treating step is carried out at a temperature from 80° C. to 120° C. In another embodiment, the heat-treating step is carried out at a temperature from 60° C. to 120° C. In another embodiment, the heat-treating step is carried out at a temperature from 40° C. to 80° C. In another embodiment, the heat treating step is carried out at a temperature 100° C. to 300° C.

In a particular embodiment, optionally in combination with one or more features of the various embodiments described above, the desorption step (b) is carried out under reduced pressure by subjecting the CO₂-containing calcium chabazite at a pressure from 0.05 to 0.7 bar, such as from 0.1 to 0.4 bar, or from 0.2 to 0.3 bar. Alternatively, the desorption step (b) can be carried out by contacting the CO₂-containing calcium chabazite with a free-CO₂ gas, such as N₂.

In another embodiment, optionally in combination with one or more features of the various embodiments described above, the heat treating step is carried out under reduced pressure such as at a pressure from 0.2 to 0.7 bar. In a particular embodiment, optionally in combination with one or more features of the various embodiments described above, the step of contacting the atmospheric air with a calcium chabazite is carried out in an open space.

As mentioned above, the method of the present disclosure can be carried out in the presence of a desiccant Advantageously, by carrying out the process in the presence of a desiccant eases both the adsorption and desorption processes.

The calcium chabazite as defined herein could also be used for the removal of carbon dioxide in an enclosed space, for the preservation of freshness of food, or for the removal of carbon dioxide contained in exhaled breath during anaesthesia.

### Preparation of the Calcium Chabazite

Chabazites having a Si/Al ratio of 1.8 to 2.4 can be prepared according to the process disclosed in U.S. Pat. No. 4,503,024. Chabazites from a Si/Al ratio of 1 to less than 1.8 can be prepared as disclosed in Barrer, R. M. and Baynham, J. W. (1956) The hydrothermal chemistry of the silicates. Part VII synthetic potassium aluminosilicates. J. Chem. Soc., 2892-2903. Chabazites from a Si/Al ratio of more than 2.4 to 5 can be prepared following a modified method of Zones, S. I. (1991). “Conversion of faujasites to high-silica chabazite SSZ-13 in the presence of N,N,N-trimethyl-1-adamantammonium iodide”. Journal of the Chemical Society, Faraday Transactions, 87(22), pp. 3709-3716. Other chabazites are prepared as shown in the examples.

Calcium zeolites can be prepared by ion exchange of the corresponding zeolite type in an aqueous solution of a water soluble calcium salt, for instance, as explained herein below. Noncommercial alkali metal zeolites, such as sodium zeolites, can be prepared following a similar procedure than for the preparation of calcium zeolites, that is by suspending the corresponding commercial or as-synthesized zeolite type, such as the corresponding K-exchanged zeolite type, in an aqueous solution of the alkali metal salt of interest, such as of sodium nitrate, sodium acetate, or sodium chloride in the case of Na-exchanged zeolites.

The calcium chabazites of the present disclosure can be prepared by calcium exchange of a chabazite having a Si/Al ratio from 1.0 to 2.3, or from 1.4 to 2.2, or from 1.5 to 2.2, or from 1.8 to 2.2, or from 1.9 to 2.2, or from 1.9 to 2.1; an alkali metal/Al ratio from 0 to 1, and, optionally, a H+/Al ratio from 0 to 1, and, optionally, an ammonium/Al ratio from 0 to 1. In particular, calcium chabazites of the present disclosure can be prepared by calcium exchange of an alkali metal exchanged chabazite, such as a Li-chabazite, a Na-chabazite, or a K-chabazite, having the above mentioned Si/Al and alkali metal/Al ratios. Calcium exchange can be carried out in an aqueous solution of a water soluble calcium salt such as Ca(NO₃)₂ or CaCl₂.

Therefore, calcium chabazites of the present disclosure can be prepared by a process comprising:
(a) providing an alkali metal ion-containing chabazite having a Si/Al ratio from 1.0 to 2.3, or from 1.4 to 2.2, or from 1.5 to 2.2, or from 1.8 to 2.2, or from 1.9 to 2.2, or from 1.9 to 2.1; an alkali metal/Al ratio from 0 to 1; and, optionally, a H+/Al ratio from 0 to 1; and optionally, NH₄⁺/Al ratio from 0 to 1.
(b) subjecting the chabazite of step a) to ion exchange in an aqueous solution of a water soluble calcium salt until obtaining a Ca/Al atomic ratio from 0.30 to 0.50 (i.e. of 60% cation exchange or higher), or from 0.40 to 0.50, or from 0.42 to 0.50, or from 0.45 to 0.50, or from 0.45 to 0.49, or from 0.46 to 0.48, in order to obtain a calcium chabazite;
(c) recovering the calcium chabazite.

To obtain the required Ca/Al atomic ratio several consecutive ion exchanges can be made. The ion exchange step can be carried out at a temperature from 0° C. to lower than 100° C., or from 40° C. to 98° C., such as of 80° C.

Calcium chabazite obtained in step (c) can be recovered by filtration and, subsequently, washed with distilled water and dried. As an example, drying can be performed at a temperature from 80 to 100° C.

In an embodiment of the method of the present disclosure, after its preparation and before being used for the first time in the method of the invention, the calcium chabazite disclosed herein can be activated by subjecting it to a dehydrating process. The dehydration process can be carried out so that the calcium chabazite has the maximum possible working capacity before being used for the first time in the method of the present disclosure.

Since the obtained calcium chabazite has an enormous affinity for water at high temperature, a dry stream treatment can be performed at temperatures above 300° C. to remove any water that the calcium chabazite may have adsorbed. Afterwards, it can be stored in a hermetically sealed container until its use or directly used in the CO₂ capture process avoiding the exposure of the adsorbent to the ambient moisture.

Particularly, the dehydration step can be performed by heat treating the calcium chabazite at a temperature equal to or higher than 300° C. in a dry stream of a gas (i.e., at least with a water concentration below 10 ppm) such as of dried air or N₂, or at vacuum (such as at a vacuum of a residual pressure of 100 mbar). More particularly, the dehydration step can be performed at a temperature from 350° C. to 450° C., such as at 400° C., in a dry stream of gas or at vacuum. Even more particularly, the dehydration step can be performed during the time needed to dehydrate the calcium chabazite, such as from 8 to 12 hours.

The calcium chabazite obtainable by the process mentioned above and also herein below (see Example) can be used in the process of the present disclosure. Therefore, it is also part of the invention the method and the uses as disclosed herein, wherein the calcium chabazite is obtainable by the process mentioned above and below (see Example).

Throughout the description and claims the word “comprise” and variations of the word, are not intended to exclude other technical features, additives, components, or steps. Furthermore, the word “comprise” encompasses the case of “consisting of”.

The following examples and drawings are provided by way of illustration, and they are not intended to be limiting of the present invention. Furthermore, the present invention covers all possible combinations of particular and preferred embodiments described herein.

### Examples

### 1. Zeolite Materials

Zeolite materials with different topologies were studied for their testing as selective adsorbents of CO₂ for direct air capture. For this purpose, low Si/Al ratio zeolites containing large cavities and different pore apertures were selected and synthesized or purchased, when commercially available, and later ion-exchanged with Ca cations. In particular, LTA and CHA zeolites with different Si/Al ratios were prepared, whereas commercial FAU zeolites were also used. The details of the preparation of the zeolites is described herein below.

### 1.1. LTA-1 Zeolites

Commercial LTA-type zeolites Molecular sieves 4A (Si/Al=1.2, Na/Al=0.9) and 5A (Si/Al=0.9, Ca/Al=0.34) were purchased from Sigma Aldrich.

### 1.2. Preparation of LTA-2 Zeolite

LTA zeolite with a nominal Si/Al=2 was synthesized following a modified recipe based on that reported for zeolite Alpha in the Verified Syntheses of Zeolitic Materials of the IZA Synthesis Commission (G. H. Küehl, U.S. Pat. No. 4,191,663, 1980).

3.1 g of sodium aluminate (54.3 wt % Al₂O₃, 42.8 wt % Na₂O, Aldrich), 28.2 g of tetramethylammonium hydroxide (TMAOH, 25 wt. % aqueous solution, Aldrich), 14.8 g of colloidal silica (Ludox AS-40, 40 wt. %, Aldrich) and 28.3 g of water were mixed under stirring to form a gel of the following molar composition:
1 SiO₂:0.17 Al₂O₃:0.78 TMAOH:0.22 Na₂O:33 H₂O

The synthesis mixture was aged at 35° C. during 24 hours prior to the crystallization at 100° C. for 28 hours. The zeolite was recovered by filtration and extensively washing with deionized water, followed by drying at 100° C.

The zeolite was then calcined at 500° C. in an oven for 3 hours to remove the occluded organic material. Chemical analysis revealed a Si/Al ratio of 1.8 and Na/Al of 0.83.

### 1.3. Preparation of LTA-5 Zeolite

The synthesis of LTA zeolite with a nominal Si/Al=5 was done basing on the method appearing on Example 1 in WO200368679A1.

2.4 g of aluminium sec-butoxide (97 wt. %, Aldrich) was added to an aqueous solution of 12 g of tetraethylammonium (TEAOH, 35 wt. % aqueous solution, Aldrich) and 11.4 g of diethyldimethylammonium (DEDMAOH, 20 wt. % aqueous solution, Aldrich) hydroxides under stirring. 14.2 g of colloidal silica (Ludox AS-40, 40 wt. %, Aldrich) were then added, and the mixture stirred for 1 h and aged at 100° C. overnight. A solution of 0.56 g of tetramethylammonium chloride (TMACl; 98 wt. %, Aldrich) and 0.3 g of NaCl (Aldrich) in 4 g of water was then added and the mixture homogenized for 30 min. The resulting gel was introduced in teflon-lined stainless steel autoclaves and the crystallization was carried out at 100° C. for 21 days under static conditions. The gel composition was:
1 SiO₂:0.05 Al₂O₃:0.3 TEAOH:0.2 DEDMAOH:0.05 TMACl:0.05 NaCl:17 H₂O

After this time, the mixture was filtered, washed with water, dried at 100° C. and the recovered zeolite was finally calcined at 500° C. Chemical analysis revealed a Si/Al ratio of 5.0 and Na/Al of 0.21.

### 1.4. FAU-1 Zeolite

Commercial FAU-type zeolite Molecular sieves 13X (Si/Al=1.2, Na/Al=1) was purchased from Sigma Aldrich.

### 1.5. FA U-2 Zeolite

Commercial FAU-type zeolite CBV100 (Si/Al=2.3, Na/Al=1) was purchased from Zeolyst Int.

### 1.6 Preparation of CHA-1.5

Chabazite with a nominal Si/Al ratio of 1.5 was prepared following a process based on that disclosed in Barrer, R. M. and Baynham, J. W., J. Chem. Soc., 2892-2903, 1956.

2 g of commercial ammonium form of zeolite Y (CBV500, Si/Al=2.6, Zeolyst Int.) were added to an aqueous solution of KOH (Aldrich, 2.21 g in 27.13 g of water). Then, 0.527 g of aluminum hydroxide (53.7% A12O₃, Aldrich) were incorporated to the mixture. the ingredients were homogenized by vigorous stirring for two hours, resulting in a gel of the following molar composition:
1 SiO₂:0.33 Al₂O₃:0.83 K₂O:75 H₂O

The mixture was introduced in Teflon-lined stainless steel autoclave and heated at 150° C. for five days under static conditions. The autoclaves were cooled down and the zeolite was recovered by filtration, exhaustive washing with deionized water and drying at 100° C. Chemical analysis revealed a Si/Al ratio of 1.3 and K/Al of 0.92.

### 1.7. Preparation of CHA-2 Zeolite

The synthesis of Chabazite with a nominal Si/Al ratio of 2 was carried out following a procedure reported on the Verified Syntheses of Zeolitic Materials of the International Zeolite Association (M. Bourgogne et al, U.S. Pat. No. 4,503,024, 1985).

2.5 g of commercial ammonium form of zeolite Y (CBV500, Si/Al=2.6, Zeolyst Int.) was added to an aqueous solution of KOH (Aldrich, 1.42 g in 21.3 g of water) in a polypropylene bottle in order to form a gel of the following molar composition:
1 SiO₂:0.19 Al₂O₃:0.03 Na₂O:0.39 K₂O:43 H₂O

The mixture was stirred for 10 minutes at room temperature and then heated at 100° C. for seven days in static conditions. The zeolite was then recovered by filtration, washing with deionized water and drying at 100° C. Chemical analysis revealed a Si/Al ratio of 2.0 and K/Al ratio of 0.97.

### 1.8. Preparation of CHA-3.5 Zeolite

Chabazite with a nominal Si/Al ratio of 3.5 was prepared according to a modified procedure based on the process disclosed in S. I. Zones, J. Chem. Soc. Faraday Trans. 87, 3709-3716, 1991.

First, N,N,N,trimethyl-1-adamantammonium iodide (RI) was prepared by alkylation of 1-adamantamine (97 wt. %, Aldrich) with methyl iodide (99 wt. %, Aldrich). 1 g of RI was added to an aqueous solution of NaOH (Aldrich, 0.19 g in 12.2 g of water) together with 4.93 g of sodium silicate solution (25.8 wt. % SiO₂, 10.7 wt. % Na₂O, Honeywell). Next, 1.5 g of ammonium form of zeolite Y (CBV500, Si/Al=2.6, Zeolyst Int.) was incorporated to the mixture. Finally, a suspension of seeds of zeolite CHA-2 (0.31 g of zeolite prepared as described in example 1.6 in 1 g of water) was also added. After homogenization of the ingredients by stirring for two hours, a gel of the following molar composition was obtained:
1 SiO₂:0.11 Al₂O₃:0.08 RI:0.28 Na₂O:0.02 K₂O:23 H₂O

The mixture was introduced in Teflon-lined stainless steel autoclaves and heated at 135° C. during seven days in static conditions. The autoclaves were cooled down and the zeolite was recovered by filtration, washing with deionized water and drying at 100° C. The zeolite was submitted to calcination in air atmosphere at 580° C. for three hours in order to remove the occluded organic. Chemical analysis revealed a Si/Al ratio of 3.4, Na/Al of 0.64 and K/Al of 0.13.

### 1.9. Preparation of CHA-5 Zeolite

Chabazite with a nominal Si/Al ratio of 5 was prepared according to the process disclosed in S. I. Zones, J. Chem. Soc. Faraday Trans. 87, 3709-3716, 1991.

First, N,N,N,trimethyl-1-adamantammonium iodide (RI) was prepared by alkylation of 1-adamantamine (97 wt. %, Aldrich) with methyl iodide (99 wt. %, Aldrich). 2.1 g of RI were added to an aqueous solution of NaOH (Aldrich, 0.12 g in 23.8 g of water) together with 13.4 g of sodium silicate solution (25.8 wt. % SiO₂, 10.7 wt. % Na₂O, Honeywell). Finally, 1.5 g of ammonium form of zeolite Y (CBV500, Si/Al=2.6, Zeolyst Int.) was incorporated to the mixture. After homogenization of the ingredients by stirring for two hours, a gel of the following molar composition was obtained:
1 SiO₂:0.04 Al₂O₃:0.09 RI:0.34 Na₂O:25 H₂O

The mixture was introduced in Teflon-lined stainless steel autoclaves and heated at 135° C. during seven days in static conditions. The autoclaves were cooled down and the zeolite was recovered by filtration, washing with deionized water and drying at 100° C. The zeolite was submitted to calcination in air atmosphere at 580° C. for three hours in order to remove the occluded organic. Chemical analysis revealed a Si/Al ratio of 5.0 and Na/Al of 0.63.

### 2. Ion Exchange Treatments

Aqueous-phase ion exchange of the zeolites with Ca²⁺ was carried out according to the following procedure:

Ca-zeolites were prepared by ion exchange of the alkali metal ion-containing zeolites by contacting the corresponding zeolite with 1M aqueous solutions of calcium (II) nitrate tetrahydrate (Ca(NO₃)₂·4H₂0) in a liquid to solid ratio of 20:1 wt/wt. Typically, 2 g of zeolite were added to 40 mL of the 1M Ca(NO₃)₂ aqueous solution and stirred at 80° C. for 2 h under reflux. The materials were recovered by filtration and extensively washed with distilled water (2 litres/g solid). The exchanged zeolites were dried at 100° C. overnight. This ion-exchange procedure was repeated several times with fresh Ca²⁺ solution until Ca/Al ratio was over 0.40 (i.e. over 80% cation exchange).

The Na exchanged chabazite of Si/Al ratio close to 2 (Na-CHA-2) was prepared by ion exchange of as-made K-CHA-2 following a similar procedure than Ca exchanges. 2 grams of K-CHA-2 was suspended in 40 mL of 1M aqueous solution of sodium nitrate (NaNO₃·6H₂O) and stirred at 80° C. for 2 hours under reflux. The solid was recovered by filtration and exhaustively washed with 4 L of distilled water. The sample was dried at 100° C. overnight. This exchange procedure was repeated four times until achieving a Na/Al ratio of 0.90.

### 3. CO₂ Adsorption Measurements

Adsorption isotherms of CO₂ were measured in a volumetric apparatus up to 1 bar. The isotherms were acquired in a volumetric adsorption analyser by submerging the samples in the appropriated holders in a liquid-circulating bath in order to run the isotherms at a constant temperature of 25° C. In some cases, measurements at other temperatures were carried out for studying the influence of the temperature in the adsorption uptake of the adsorbent.

Approximately 150 mg of adsorbent (zeolite) were placed in the sample holder and then evacuated (at least 10⁻³ mbar) to remove any residual gas or moisture that could be present, using a vacuum pump and heating at 400° C. overnight. Once the sample was evacuated, a known quantity of CO₂ was introduced into the chamber, expanding from the calibrated manifold, which volume, temperature, and pressure were carefully measured. The gas dosing was 2 cm³/g for acquiring high resolution isotherms at ultra low CO₂ pressures, such as 0.4 mbar.

The pressure of CO₂ on the sample was measured upon reaching gas-solid equilibrium, and the amount of gas adsorbed by the adsorbent was determined. This process was repeated for a range of different pressures, from very low pressures up to 1 bar.

The analysis conditions were carefully defined to ensure that the equilibrium was reached. For microporous samples, about a 500-second equilibrium time would be enough when using CO₂ at 25° C. It was guaranteed by using 11 pressure readings with a 45-second equilibrium interval between them, and calculating the weighted average pressure drop over these 11 values. The pressure change as a rate in the central point was also calculated through the first derivative. Therefore, the equilibrium was defined only when the rate of change of pressure for the central point (6th data point) was lower than 0.01%. Otherwise, another point was taken and discarding the oldest data point until the pressure rate change fulfilled the requirements.

The detailed description is referred to the measurements carried out at 25° C. The measurement procedures for other temperatures were identical except the consigned temperature. Once all the data was collected, it was plotted on a graph with the amount of gas adsorbed on the y-axis and the pressure on the x-axis.

4. Results Obtained with LTA Zeolites (Comparative Examples)

Type LTA zeolite is a small pore material containing large cavities and pore apertures of 4.1 Å. This zeolite can be synthesized in the widest Si/Al ratio possible, from 1 to the pure silica composition. In this study, zeolites LTA with Si/Al ratios of 1, 2, and 5 were used.

LTA zeolites with Si/Al=1 are commercially available in Na (commercial name 4A, here Na-LTA-1) and Ca (commercial name 5A, here Ca-LTA-1) forms. The commercial zeolite 5A shows a significant amount of Na as compensating cations. Thus, this material was submitted to one Ca²⁺ exchange as described above for increasing its Ca/Al ratio. The resulting zeolite reached a Ca/Al ratio of 0.46 (i.e. 92% Ca exchange).

LTA zeolites of Si/Al ratios of 2 and 5 were synthesized as described above with Na⁺ and H⁺ as compensating cations (H⁺s are formed during the calcination of the occluded organic and named as Na-LTA-2 and Na-LTA-5, respectively) and ion exchanged by Ca²⁺ as it was described previously, resulting in samples Ca-LTA-2 ad Ca-LTA-5. The chemical compositions of the LTA samples are shown in Table 1.

TABLE 1
Chemical compositions of zeolites LTA.

| Sample | Chemical composition |
|---|---|
| Na-LTA-1 (commercial name 4A) | Si_{1.2}Al₁O_{4.4}Na_{0.94} |
| Ca-LTA-1 (commercial name 5A) | Si_{0.9}Al₁O_{3.8}Na_{0.32}Ca_{0.34} |
| Ca exchanged - 5A | Si_{0.9}Al₁O_{3.8}Na_{0.04}Ca_{0.46} |
| Na-LTA-2 | Si_{1.8}Al₁O_{5.6}Na_{0.83} |
| Ca-LTA-2 | Si_{1.9}Al₁O_{5.8}Na_{0.01}Ca_{0.35} |
| Na-LTA-5 | Si_{5.0}Al₁O_{12.0}Na_{0.21} |
| Ca-LTA-5 | Si_{5.4}Al₁O_{12.8}Ca_{0.23} |

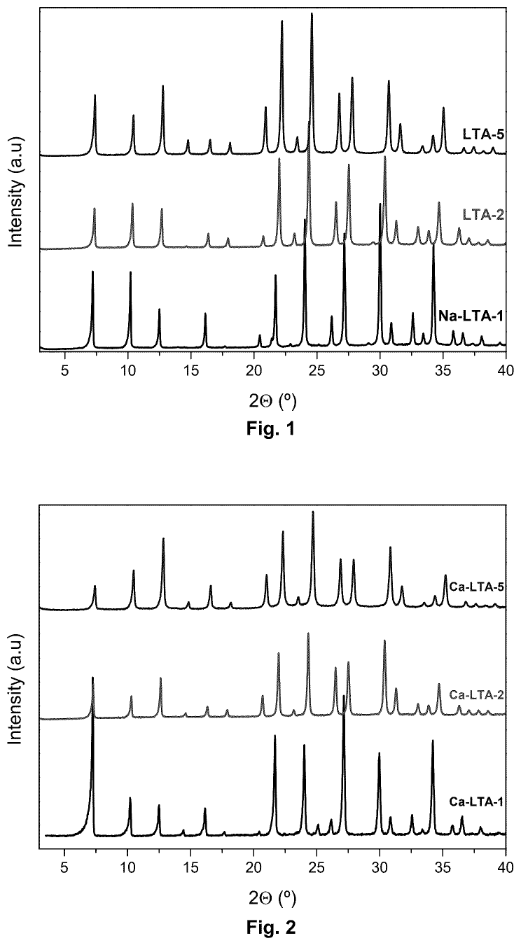

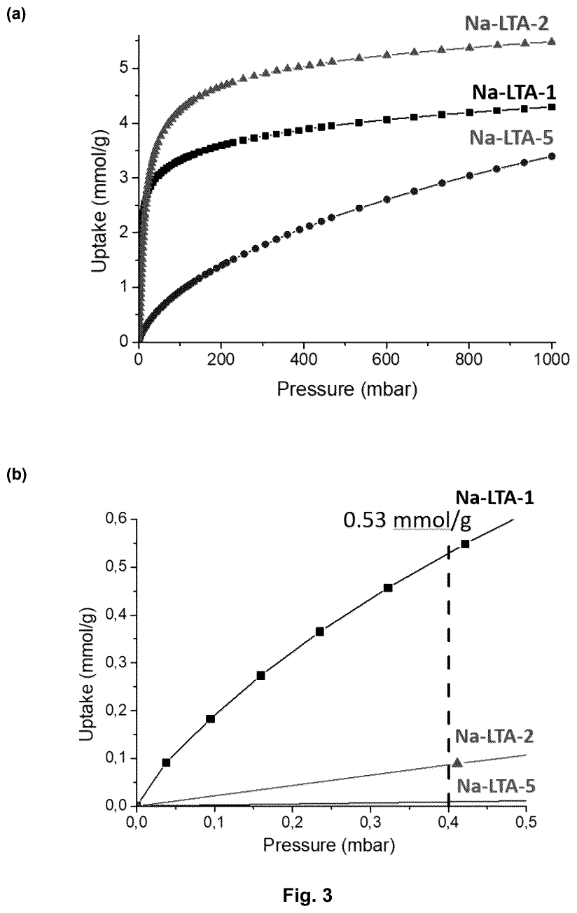

X-ray diffraction (XRD) patterns of the Na,H-LTA zeolites are shown in FIG. 1, where it is evidenced that the zeolites are of high crystallinity. The small shifts of the X-Ray diffraction lines between the samples are due to differences in their unit cell parameters as consequence of the smaller ionic diameter of Si atoms than that of Al ones. This results in a decrease of the unit cell parameter as the Si/Al ratio becomes higher in the LTA zeolites. Also, FIG. 2 shows the XRD patterns of the Ca exchanged zeolites, where it is observed that the crystallinity is preserved and no amorphous or extra-phases different than zeolite of LTA structure are detected.

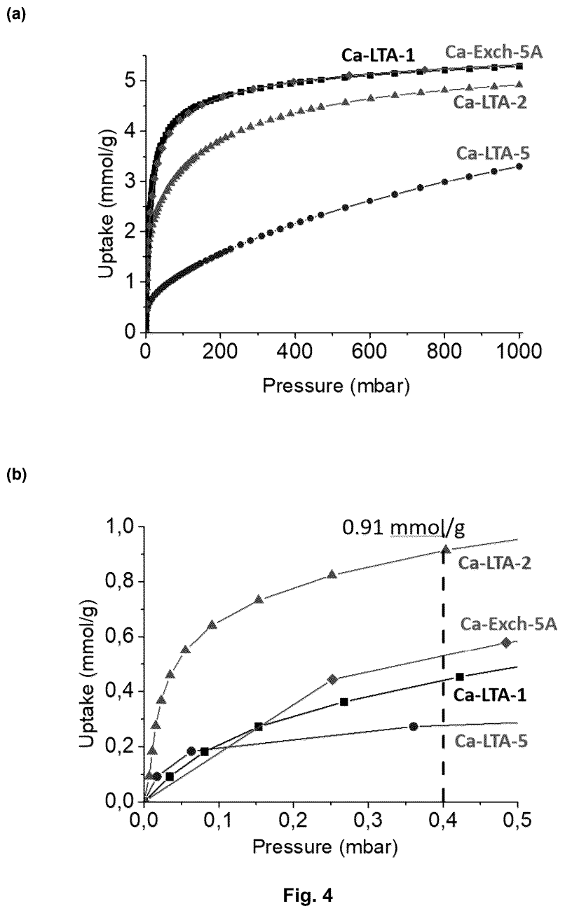

The CO₂ adsorption isotherms measured at 25° C. of the series of Na,H-LTA zeolites are shown in FIG. 3. There, it is observed that Na-LTA-2 shows the highest adsorption capacity at high pressure and Na-LTA-1 at ultra-low CO₂ pressures, being able to adsorb 0.53 mmol/g of CO₂ at 0.4 mbar (equivalent to 400 ppm).

Notoriously, the total CO₂ adsorption capacity of LTA-2 remains nearly constant by replacing Na⁺ by Ca²⁺ as compensating cations. However, its adsorption uptake of CO₂ dramatically increases at ultra-low pressures reaching 0.91 mmol/g at 0.4 mbar (equivalent to 400 ppm of CO₂). All other Ca-LTA samples provide adsorption capacities below 0.55 mmol/g regardless of the Ca content of the material.

5. Results Obtained with FAU Zeolites (Comparative Examples)

FAU type zeolite is a large pore material containing large supercavities and pore aperture of 7.4 Å. FAU zeolites with Si/Al ratios around 1 and 2 are commercially available in Na form as 13X (Merck) and CBV100 (Zeolyst Int. Int.), respectively. The corresponding Ca containing samples were prepared by ion exchange of the parent Na-zeolites as described above. The exchange levels (expressed as Ca/Al) were 0.42 for FAU-2 and 0.46 for FAU-1 as it is shown in Table 2.

TABLE 2
Chemical compositions of zeolites FAU.

| Sample | Chemical composition |
|---|---|
| Na-FAU-1 (commercial name 13X) | Si_{1.2}Al₁O_{4.4}Na₁ |
| Ca-FAU-1 | Si_{1.1}Al₁O_{4.2}Na_{0.03}Ca_{0.46} |
| Na-FAU-2 (commercial name CBV-100) | Si_{2.3}Al₁O_{6.6}Na₁ |
| Ca-FAU-2 | Si_{2.3}Al₁O_{5.6}Na_{0.14}Ca_{0.42} |

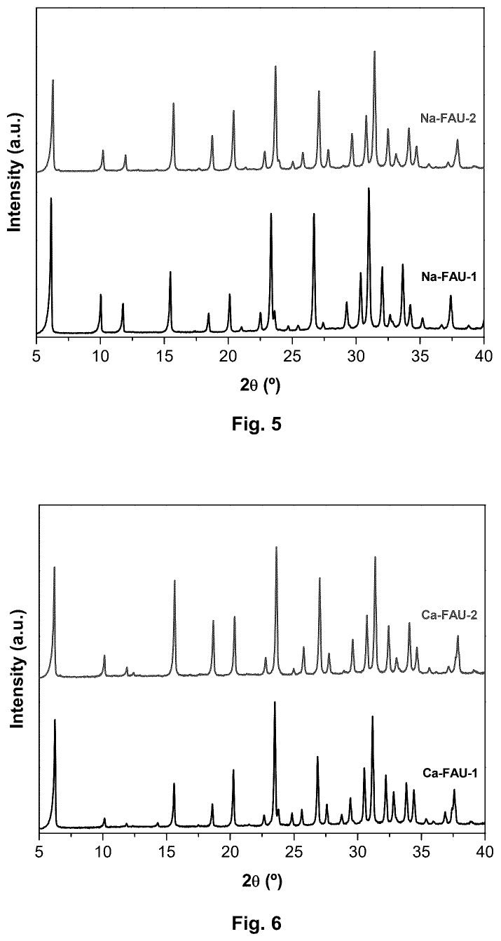

The XRD patterns of the commercial Na-FAU-1 and Na-FAU-2 (13X from Merck and CBV-100 from Zeolyst, respectively) are shown in FIG. 5, whilst the corresponding XRD patterns of Ca-exchanged FAU samples, Ca-FAU-1 and Ca-FAU-2, are reported in FIG. 6.

It is evidenced that the crystalline structure is maintained in the Ca-FAU samples and the presence of impurities is discarded.

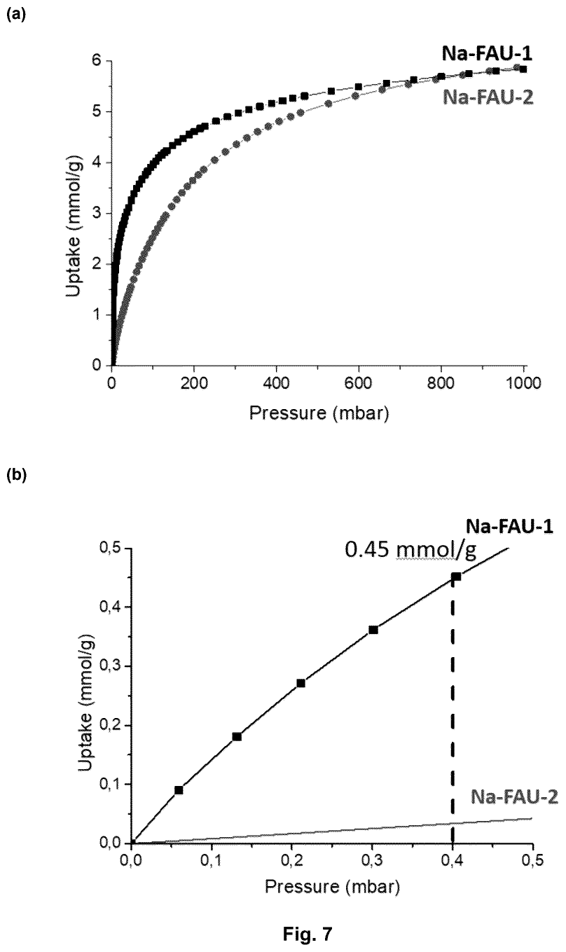

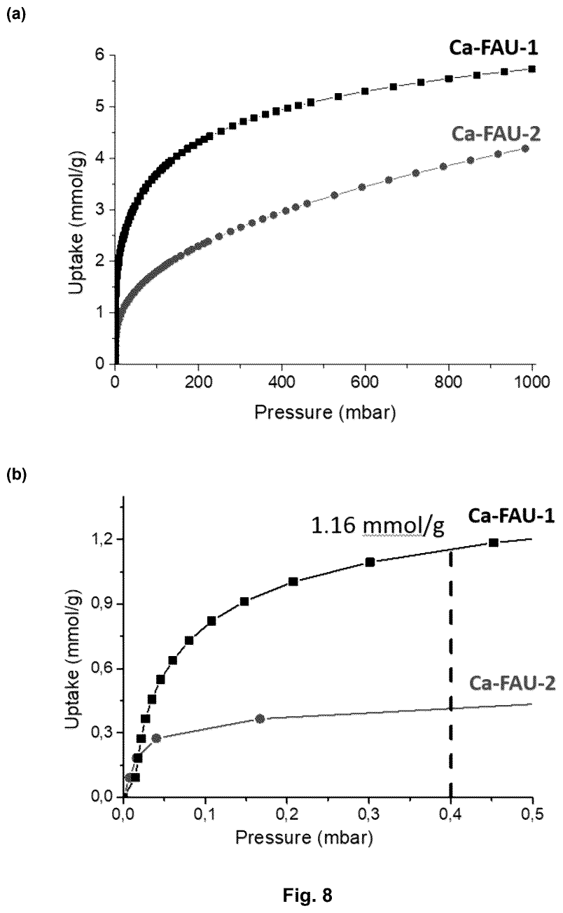

The CO₂ adsorption isotherms measured at 25° C. of the series of FAU zeolites are shown in FIG. 7 and FIG. 8. There, it is observed that Na-FAU-1 and Na-FAU-2 samples have similar adsorption capacities at a CO₂ pressure of 1 bar, whereas in the low pressure range, Na-FAU-1 has the largest capacity at 0.4 mbar (0.45 mmol/g). The isotherms of Ca-exchanged FAU samples indicate that zeolite Ca-FAU-1 shows much higher uptake than the parent Na-FAU-1 at ultra-low CO₂ pressure (1.16 mmol/g), being also larger (slightly more than twice as high) than that of Ca-FAU-2, as it is shown in FIG. 8.

6. Results Obtained with CHA Zeolites (Examples)

Zeolites CHA with Si/Al ratios of 2 and 5, which were synthesized as described above; chabazite of Si/Al=2 in K⁺ form (named as K-CHA-2); and chabazite of Si/Al=5 as Na⁺, H⁺ form (named as Na-CHA-5) were used (Table 3). K-CHA-2 and Na-CHA-5 were transformed in the Ca²⁺ form by exhaustive ion exchange until a Ca/Al ratio higher than 0.4 was reached. Additionally, for comparison purposes, the sample K-CHA-2 was transformed in Na-CHA-2 by consecutives ion exchanges until a Na/Al ratio of 0.9 was obtained.

TABLE 3
Chemical compositions of zeolites CHA

| Sample | Chemical composition |
|---|---|
| K-CHA-1.5 (Comparative example) | Si_{1.3}Al₁O_{4.6}K_{0.92} |
| Ca-CHA-1.5 | Si_{1.4}Al₁O_{4.8}Ca_{0.38}K_{0.1} |
| K-CHA-2 (Comparative example) | Si_{2.0}Al₁O₆K_{1.0} |
| Na-CHA-2 (Comparative example) | Si_{1.9}Al₁O_{5.8}Na_{0.9}K_{0.05} |
| Ca-CHA-2 (Example) | Si_{1.9}Al₁O_{5.8}Ca_{0.45}K_{0.08} |
| K, Na-CHA-3.5 (Reference example) | Si_{3.4}Al₁O_{8.8}K_{0.13}Na_{0.64} |
| Ca-CHA-3.5 (Reference example) | Si_{3.5}Al₁O₉Ca_{0.38}K_{0.02}Na_{0.02} |
| Na-CHA-5 (Comparative example) | Si_{5.0}Al₁O₁₂Na_{0.63} |
| Ca-CHA-5 (Comparative example) | Si_{5.9}Al₁O_{12.8}Ca_{0.42} |

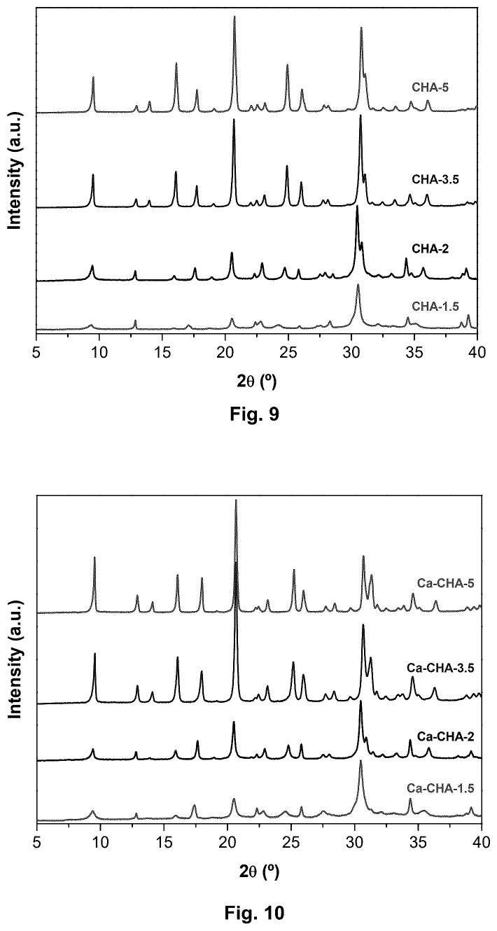

The XRD patterns of K, Na and Ca Chabazite samples are shown in FIGS. 9 and 10. There, it is seen that differences on some X-Ray diffraction peaks occur. These differences are attributed to the presence of K⁺ cations as compensating cations in sample CHA-2, while Na⁺ and H⁺ are present in zeolite CHA-5. The very different electronic densities of these cations result in large differences in the intensities of the X-Ray peaks. Also, it is appreciable the shifting of the X-Ray diffraction peaks towards low angles of the CHA-2 samples (independently of the compensating cations) with respect to the zeolites CHA-5. These differences are attributed to the different rhombohedral unit cell parameters of K-CHA-2 and Na-CHA-5 zeolites. The smaller size of Si compared to Al atoms produces the shrinkage of the unit cell as the Si/Al ratio increases, resulting in a shift of the XRD peaks towards high angles in the diffraction pattern as experimentally observed in FIGS. 9 and 10.

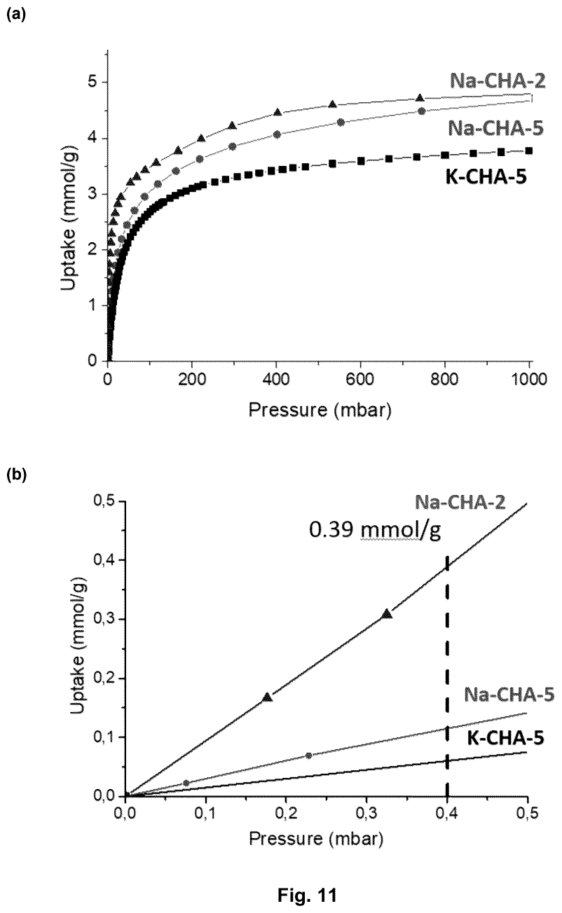

The isotherms of CO₂ measured at 25° C. on K-CHA-2, Na-CHA-2, and Na-CHA-5 zeolites are shown in FIG. 11. There, it is seen that the adsorption uptake of Na-CHA-2 zeolite is higher than that observed in Na-CHA-5 zeolite and both higher than K-CHA-2 in the whole range of pressures. This result indicates that there is an important influence of the cationic radius of the compensating cation and also, of the Al content of the zeolitic adsorbent.

As shown in the comparative examples above, uptakes near 1 mmol/g have been obtained on Ca-FAU-1 (1.16 mmol/g) and Ca-LTA-2 (0.9 mmol/g).

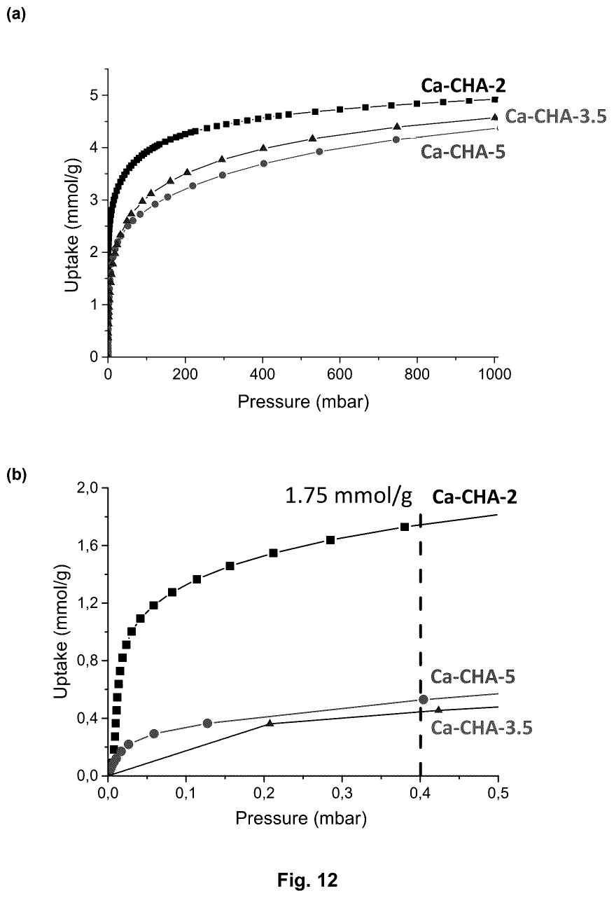

As shown in FIG. 12, Ca-CHA-2 zeolite exhibits an unexpectedly pronounced square shaped isotherm, that is with a very high adsorption capacity at ultra-low CO₂ pressures. In particular, ~35% of the total CO₂ uptake is reached at 0.4 mbar, resulting in a total CO₂ adsorption capacity of 1.75 mmol/g at 0.4 mbar (equivalent to 400 ppm of CO₂) a value that is more than four times higher than with Na-CHA-2. To the best of our knowledge, this is the highest CO₂ uptake observed on a zeolite up to now at ultra-low CO₂ pressures needed for DAC.

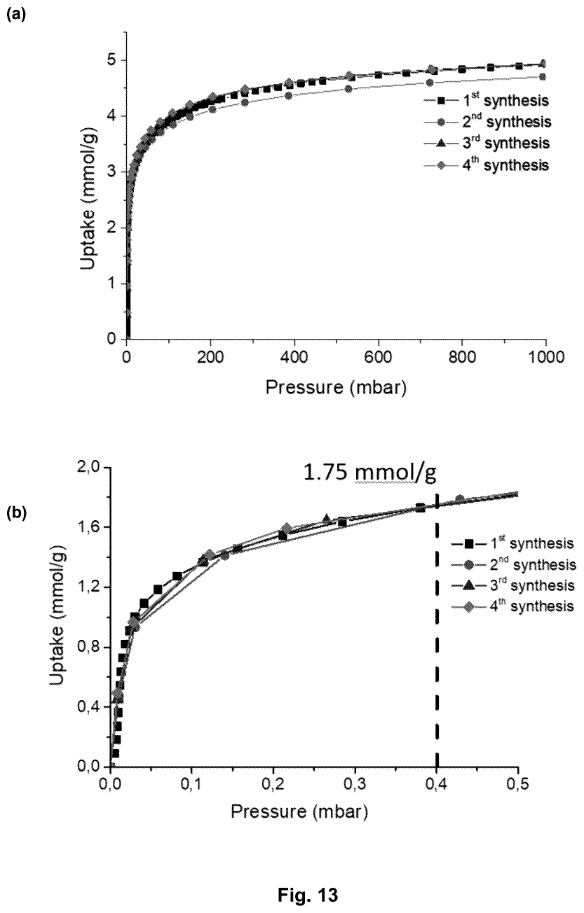

This unexpected result has been confirmed and several preparations of zeolites Ca-CHA-2 have been obtained with similar Ca/Al ratios (always higher than 0.4 as it is shown in Table 4). All these Ca-CHA-2 samples show CO₂ uptakes around 1.75 mmol/g at ultra-low pressures (within the experimental error) as shown in FIG. 13.

TABLE 4
Chemical compositions of different zeolites
Ca-CHA-2 for studying its reproducibility

| Sample | Chemical composition |
|---|---|
| Ca-CHA-2 (1^{st} synthesis) | Si_{1.9}Al₁O_{5.8}Ca_{0.45}K_{0.08} |
| Ca-CHA-2 (2^{nd} synthesis) | Si_{2.2}Al₁O_{6.4}Ca_{0.45}K_{0.06} |
| Ca-CHA-2 (3^{rd} synthesis) | Si_{1.9}Al₁O_{5.8}Ca_{0.45}K_{0.11} |
| Ca-CHA-2 (4^{th} synthesis) | Si_{2.1}Al₁O_{6.2}Ca_{0.44}K_{0.09} |

Finally, we have carried out a systematic study of the influence of the Ca/Al in chabazites having a Si/Al very close to 2. For achieving different Ca/Al, the K-CHA-2 was submitted to subsequent Ca exchanges using different concentrations of Ca in the exchange solution and maintaining the Liquid/Solid ratio and temperature constant at 80° C. The exchange conditions and chemical composition of the Ca-CHA samples are shown in Table 5.

TABLE 5
Ca exchange conditions and chemical compositions of
the zeolites Ca-CHA-2 having different Ca/Al ratios

| | Ca²⁺ | | |
|---|---|---|---|
| | Concentration | No of | |
| Sample | (mol/L) | exchanges | Chemical composition |
| Ca-CHA-2-0.17 | 0.025 | 1 | Si_{2.0}Al₁O_{6.0}Ca_{0.17}K_{0.64} |
| Ca-CHA-2-0.22 | 0.05 | 1 | Si_{2.0}Al₁O_{6.0}Ca_{0.22}K_{0.55} |
| Ca-CHA-2-0.25 | 0.1 | 1 | Si_{2.0}Al₁O_{6.0}Ca_{0.25}K_{0.5} |
| Ca-CHA-2-0.37 | 1 | 1 | Si_{2.0}Al₁O_{6.0}Ca_{0.37}K_{0.24} |
| Ca-CHA-2-0.44 | 1 | 2 | Si_{2.0}Al₁O_{6.0}Ca_{0.44}K_{0.12} |
| Ca-CHA-2-0.45 | 1 | 3 | Si_{1.9}Al₁O_{5.8}Ca_{0.45}K_{0.08} |
| Ca-CHA-2-0.46 | 1 | 4 | Si_{2.0}Al₁O_{6.0}Ca_{0.46}K_{0.06} |

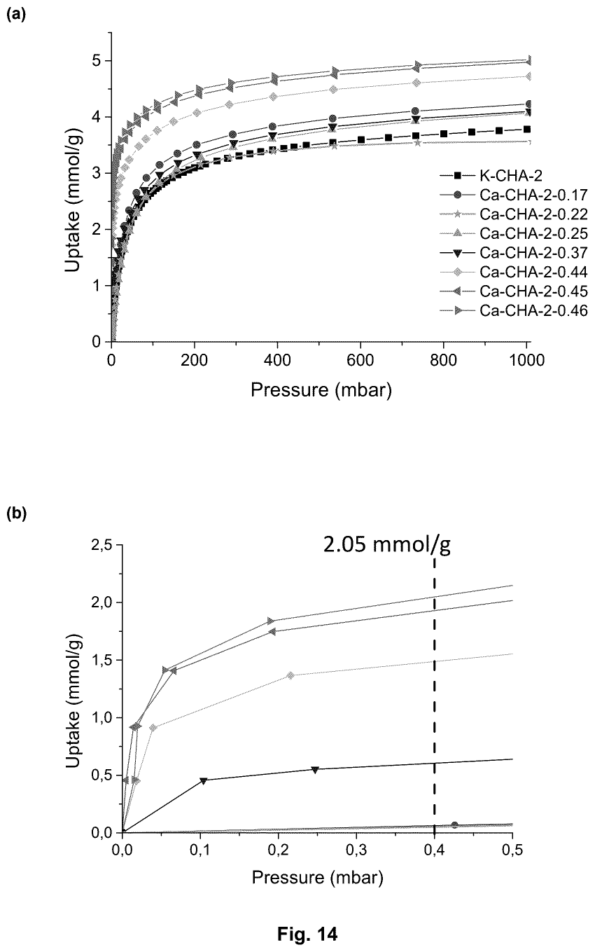

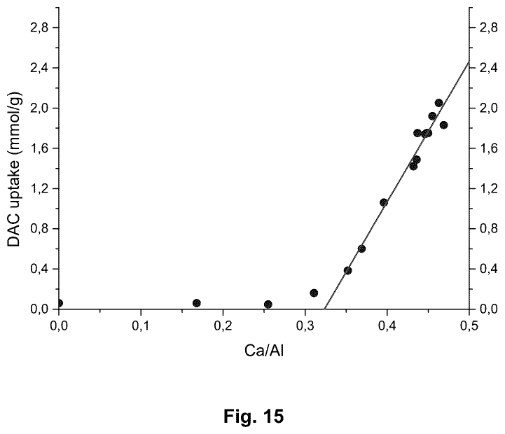

The isotherms of CO₂ measured at 25° C. on the series of zeolites CHA-2 with different ratio Ca/Al are shown in FIG. 14. There, it is seen that the adsorption uptake increases with the Ca/Al ratio. The sample with the highest experimental Ca/Al ratio (Ca-CHA-2-0.46) reached in the series shows a CO₂ uptake at 0.4 mbar and 25° C. of 2.05 mmol/g that exceeds any reported value for any zeolite to our best knowledge. This result indicates that the Ca content for CHA-2 is very important parameter in the CO₂ uptake at very low partial pressures.

This is better observed in FIG. 15, where the uptake of CO₂ at 0.4 mbar of pressure and 25° C. of temperature versus the Ca/Al ratio of the Chabazite sample of Si/Al ratio close to 2 is plotted. This Figure clearly illustrates that a maximum CO₂ uptake at low pressure and room temperature (DAC conditions) using Chabazite is at least 2.46 mmol/g when the Si/Al ratio of the zeolitic adsorbent is near 2.

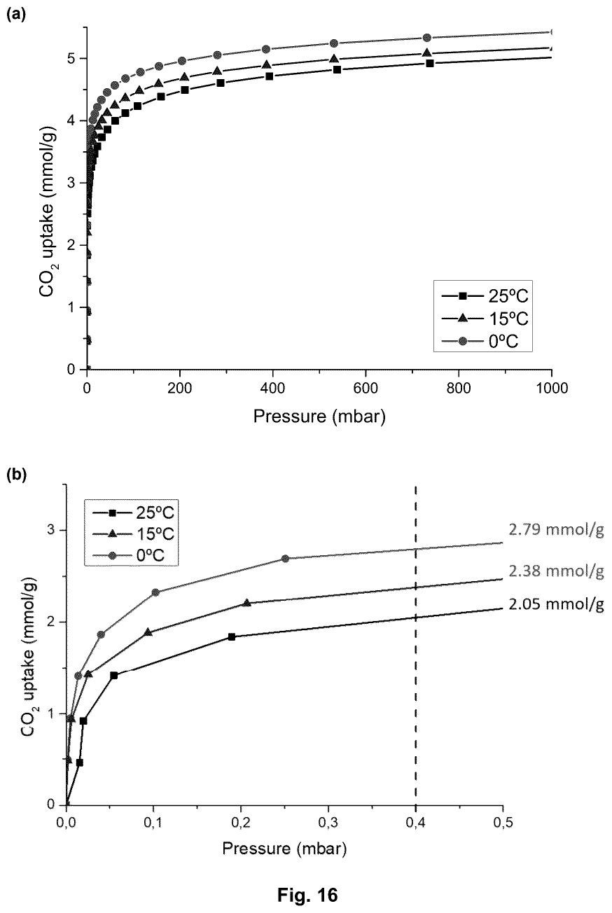

Finally, we have studied the influence of the temperature of adsorption (i.e. temperature of the DAC process) in the adsorption of CO₂ at ultralow pressures. FIG. 16 shows the increment of the CO₂ uptake in the range of 0° C. to 25° C. There, it is observed a significant increase of the CO₂ uptake as the adsorption temperature decreases, reaching a maximum uptake at 0.4 mbar of 2.79 mmol/g.

### Summary of the Results

Ca exchanged chabazites have shown the best adsorption uptake at ultra-low partial pressure of CO₂ (0.4 mbar), similar to that of the atmosphere (400 ppm). Particularly, Ca-Chabazite of Si/Al ratio near to two has provided the best adsorption capacity reported in the prior art, reaching an outstanding 2.06 mmol/g of CO₂ adsorption at 0.4 mbar and 25° C., being higher that uptakes on reference samples, such as Ca-FAU-1 (also, named as Ca-13X) and Ca-LTA-1 (also, named as 5A). The very high uptake of this Ca-chabazite is related to its low Si/Al ratio and its very high Ca exchange percentage (of 0.3 or higher, such as of 0.4, given as Ca/Al ratio).

In view of the above, it can be stated that the knowledge of the CO₂ adsorption capacity of a cation exchanged zeolite of a certain type (structure), chemical composition (Si/Al and/or exchange cation/Al) and exchange cation at a relatively high a partial CO₂ pressure does not allow to predict the CO₂ adsorption capacity of the same cation exchanged zeolite at ultralow partial pressure of CO₂ such as in DAC.

Thus, as mentioned above, surprisingly, the inventors found that the combination of Ca²⁺ as exchange cation and chabazite structure (CHA) having a Si/Al ratio from 1.0 to 2.3 (in particular, from 1.8 to 2.2) provided a calcium zeolite having a much higher CO₂ adsorption capacity at ultralow partial pressure of CO₂ (400 ppm; 0.4 mbar) than any other zeolite reported until now. As an instance, in Stuckert et al. (ibid) a CO₂ uptake as high as 1.34 mmol/g has been reported for a Li-exchanged zeolite X (Li-LSX), while the calcium chabazite (Ca-CHA-2) of the present disclosure provides a CO₂ uptake of 2.05 mmol/g (FIG. 14), i.e. a 53% larger uptake than Li-LSX and 290% larger than Ca-LSX zeolite, both data reported in Stuckert et al. (ibid).

Besides, the use of Ca²⁺ versus Li⁺ as exchange cation is desired since Li is much less abundant than Ca and its shortage is expected to be critical in the near future due to its very large demand for batteries.

### 7. Calcium Chabazite Regeneration

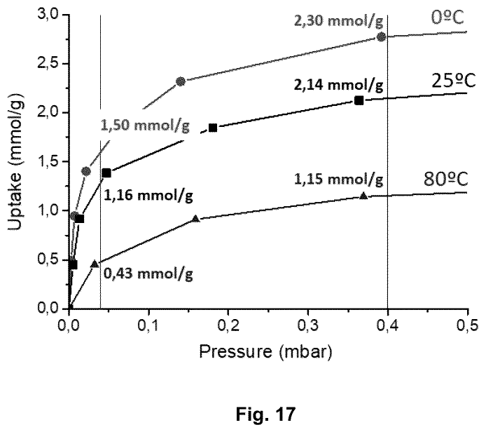

Adsorption conditions at a temperature close to 25° C. and one atmosphere of dry air pressure (1000 mbar) containing 400 ppm of CO₂ was considered as an example. This corresponded to the isotherm point at a CO₂ pressure of 0.4 mbar and 25° C. That is, as shown in FIG. 17, under these conditions 2.14 mmol/g CO₂ were adsorbed.

In a Vacuum Pressure Swing adsorption (VPSA) process, taking for instance a total residual pressure of 100 mbar (that is, the partial pressure of CO₂ would be 0.04 mbar) 1.16 mmol/g CO₂ would be adsorbed (FIG. 17). Thus, the working capacity of the adsorbent would be 0.98 mmol/g under these adsorption-regeneration cycle conditions.

In an example, a VTSA process can be carried out by increasing the desorption temperature to 80° C. during regeneration while decreasing the pressure to 100 mbar residual vacuum pressure in the unit (i.e. 0.04 mbar CO₂ partial pressure). Under these conditions, 0.43 mmol/g CO₂ would be adsorbed on Ca-CHA-2 (FIG. 17). Therefore, the working capacity of the adsorbent would increase up to 1.71 mmol/g.

In another example, dry air flow with 400 ppm CO₂ (0.4 mbar CO₂ partial pressure) at 25° C. could be maintained (2.14 mmol/g adsorption capacity, FIG. 17) and, then, carrying out a TSA process by simply increasing the temperature to 80° C. (1.15 mmol/g CO₂ will be retained) without changing the CO₂ partial pressure. This would be a TSA process with a working capacity of 0.99 mmol/g.

The working capacity could be increased if the unit operates during the adsorption cycle at lower temperature, since under these conditions the amount of CO₂ adsorbed by the material will increase as shown in the CO₂ isotherm at 0° C. (upper line in FIG. 17). In comparison to conducting the adsorption step at 25° C., lowering the temperature during the adsorption step down to 0° C. yields significant enhancements in working capacities for both TSA and VTSA desorption processes, by 0.16 mmol/g. Conversely, in the VPSA process, the observed increase amounts to 0.07 mmol/g

For reasons of completeness, the following further embodiments of the invention are set out as follows:

Embodiment 1. A method of capturing carbon dioxide from a low-CO₂-content gaseous source, the method comprising contacting the low-CO₂-content gaseous source with a calcium chabazite having a Si/Al atomic ratio from 1.0 to 5 and a Ca/Al atomic ratio from 0.30 to 0.50, such that the carbon dioxide in the gaseous source is adsorbed by the calcium chabazite,
wherein the low-CO₂-content gaseous source is a gas mixture having a CO₂ content in a range from 200 ppm to 1000 ppm measured at standard temperature and pressure.

Embodiment 2. The method of embodiment 1, wherein the calcium chabazite has a Si/Al atomic ratio from 1.8 to 3.5, or 1.8 to 2.4 or from 1.9 to 2.2 or from 1.9 to 2.1.

Embodiment 3. The method of embodiments 1 or 2, wherein the calcium chabazite has a Ca/Al atomic ratio from 0.40 to 0.50 or from 0.45 to 0.49.

Embodiment 4. The method of any one of embodiments 1 to 3, wherein the calcium chabazite is in a contacted form such as monoliths, fibers, filters, mesh, coatings, pellets, or powder.

Embodiment 5. The method of any one of embodiments 1 to 4, wherein the CO₂ content is from 350 to 900 ppm.

Embodiment 6. The method of any one of embodiments 1 to 5, wherein the low-CO₂-content gaseous source is air.

Embodiment 7. The method of any one of embodiments 1 to 6, wherein the calcium chabazite is contacted with a low-CO₂-content gaseous source having a total pressure of 1013±150 mbar.

Embodiment 8. The method of any one of embodiments 1 to 7, which is carried out at a temperature from −10° C. to 50° C., particularly at room temperature.

Embodiment 9. The method of any one of embodiments 1 to 8, which is carried out under dry conditions.

Embodiment 10. The method of any one of embodiments 1 to 9, further comprising an additional step of subjecting the calcium chabazite containing the adsorbed CO₂ to a desorption step and, optionally, recovering the desorbed CO₂.

Embodiment 11. The method of embodiment 10, wherein the desorption step is carried out by heat-treating the calcium chabazite containing the adsorbed CO₂ at a temperature from 50° C. to 500° C.

Embodiment 12. The method of embodiment 11, wherein the heat-treating step is carried out under reduced pressure.

Embodiment 13. Use of a device comprising a calcium chabazite as defined in any one of embodiments 1 to 4 for capturing CO₂ from a gaseous source having a CO₂ content from 200 ppm to 1000 ppm.

Embodiment 14. The use of embodiment 13, wherein the gaseous source has a CO₂ content from 350 ppm to 900 ppm.

### CITATION LIST

### Non Patent Literature

1. Wilson, S. M., & Tezel, F. H. (2020). Direct dry air capture of CO₂ using VTSA with faujasite zeolites. Industrial & Engineering Chemistry Research, 59(18), pp. 8783-8794. doi:10.1021/acs.iecr.9b04803.
2. Stuckert, N. & Yang, R. (2011). CO₂ Capture from the Atmosphere and Simultaneous Concentration Using Zeolites and Amine-Grafted SBA-15. Environmental science & technology. 45(23), pp. 10257-64. 10257-64. doi:10.1021/es202647a.
3. Low, M. Y. A., Barton, L., Pini, R., & Petit, C. (2023). Analytical review of the current state of knowledge of adsorption materials and processes for direct air capture. Chemical Engineering Research and Design, 189, pp. 745-767. doi:10.1016/j.cherd.2022.11.040.
4. Zhang, J. et al. (2008), “Alkali and alkaline earth cation exchanged chabazite zeolites for adsorption based CO₂ capture,” Microporous Mesoporous Materials, p. 478-487. doi:10.1016/j.micromeso.2007.08.022.
5. Du, T. et al. (2017). Preparation of zinc chabazite (ZnCHA) for CO₂ capture. Research on Chemical Intermediates, 43, pp. 1783-1792. doi:10.1007/s11164-016-2729-y
6. Julbe, A., & Drobek, M. (2014). Zeolite A Type. Encyclopedia of Membranes, 1-2. doi:10.1007/978-3-642-40872-4_604-1.
7. Julbe, A., & Drobek, M. (2014). Zeolite X Type. Encyclopedia of Membranes, 1-2. doi:10.1007/978-3-642-40872-4_607-1.
8. Julbe, A., & Drobek, M. (2014). Zeolite Y: Type. Encyclopedia of Membranes, 1-2. doi:10.1007/978-3-642-40872-4_608-1.
9. http://www.iza-online.org/natural/Datasheets/Chabazite/chabazite.htm, IZA website 2023.
10. R. W. Grosse-Kunstleve, G. O. Brunner and N. J. A. Sloane. (1996) Algebraic Description of Coordination Sequences and Exact Topological Densities for Zeolites. Acta Crystallogr. A52, 879-889.
11. M. O'Keeffe and S. T. Hyde. (1997). Vertex symbols for zeolite nets. Zeolites 19, 370-374.
12. Barrer, R. M. and Baynham, J. W. (1956) The hydrothermal chemistry of the silicates. Part VII synthetic potassium aluminosilicates. J. Chem. Soc., 2892-2903
13. Zones, S. I. (1991). “Conversion of faujasites to high-silica chabazite SSZ-13 in the presence of N,N,N-trimethyl-1-adamantammonium iodide”. Journal of the Chemical Society, Faraday Transactions, 87(22), pp. 3709-3716.

### Patent Literature

14. U.S. Pat. No. 4,503,024
15. U.S. Pat. No. 4,191,663
16. WO200368679A1

1. A method of capturing carbon dioxide from atmospheric air, the method comprising contacting the atmospheric air with a calcium chabazite having a Si/Al atomic ratio from 1.0 to 2.3 and a Ca/Al atomic ratio from 0.30 to 0.50, such that the carbon dioxide in the atmospheric air is adsorbed by the calcium chabazite,
wherein the atmospheric air has a CO₂ content in a range from 200 ppm to 1000 ppm measured at standard temperature and pressure;
wherein the atmospheric air has a pressure of 1013±150 mbar; and wherein the method is carried out at a temperature from −10° C. to 50° C.

2. The method of claim 1, wherein the calcium chabazite has a total CO₂ adsorption capacity from 1.75 mmol/g to 2.06 mmol/g at 0.4 mbar.

3. The method of claim 1, wherein the calcium chabazite has a Si/Al atomic ratio from 1.0 to 2.2.

4. The method of claim 1, wherein the calcium chabazite has a Ca/Al atomic ratio from 0.40 to 0.50.

5. The method of claim 1, wherein, before contacting the calcium chabazite with the atmospheric air, the calcium chabazite is subjected to a dehydration step.

6. The method of claim 1, wherein the calcium chabazite is in a contacted form selected from the group consisting of monoliths, fibers, filters, mesh, coatings, pellets, and powder.

7. The method of claim 1, which wherein the method is carried out at a temperature from 0° C. to 45° C.

8. The method of claim 1, wherein the method is carried out under dry conditions.

9. The method of claim 8, wherein atmospheric air comprises water in an amount of up to 5 ppm when operating at 10° C., and in an amount of up to 10 ppm when operating at 25° C.

10. The method of claim 1, further comprising an additional step of subjecting the calcium chabazite containing the adsorbed CO₂ to a desorption step.

11. The method of claim 10, wherein the desorption step is carried out by increasing the temperature, or by decreasing the pressure, or by increasing the temperature and decreasing the pressure.

12. The method of claim 11, wherein the desorption step is carried out by heat-treating the calcium chabazite containing the adsorbed CO₂ at a temperature from 40° C. to 120° C.

13. The method of claim 12, wherein the heat-treating step is carried out under reduced pressure.

14. A method for capturing CO₂ from atmospheric air having a CO₂ content from 200 ppm to 1000 ppm, the method comprising contacting the atmospheric air with a device comprising the calcium chabazite as defined in claim 1.

15. The method of claim 14, wherein the atmospheric air has a CO₂ content from 350 ppm to 900 ppm.

16. The method of claim 2, wherein the calcium chabazite has a Si/Al atomic ratio from 1.0 to 2.2 and a Ca/Al atomic ratio from 0.40 to 0.50.

17. The method of claim 5, wherein the dehydration step is carried out by heat treating the calcium chabazite at a temperature equal to or higher than 300° C. in a dry stream of dried air or N₂, or at vacuum.

18. The method of claim 7, wherein the temperature is room temperature.

19. The method of claim 18, wherein the method is carried out under dry conditions.

20. The method of claim 10, further comprising recovering the desorbed CO₂.
